(19) United States
(12) Patent Application Publication
(10) Pub. No.: US 2015/0258864 A1
(43) Pub. Date: Sep. 17, 2015

(54) WHEEL FOR MOTOR VEHICLE

(71) Applicant: Dr. Ing. h.c. F. Porsche Aktiengesellschaft, Stuttgart (DE)

(72) Inventors: Andreas HIGLE, Stuttgart (DE); Thomas HUNN, Moensheim (DE); Gerd BURK, Wolfach (DE); Georg Wahl, Pforzheim (DE)

(21) Appl. No.: 14/658,813

(22) Filed: Mar. 16, 2015

(30) Foreign Application Priority Data
Mar. 17, 2014 (DE) 102014103608.5

(51) Int. Cl. B60C 23/04; B60B 21/04; B60B 1/12; B60B 3/02; B60B 3/10

(52) U.S. Cl. CPC B60C 23/0491; B60B 3/02; B60B 3/10; B60B 1/12; B60B 21/04; B60B 2360/36; B60B 2900/3316

(57) ABSTRACT

The wheel for a motor vehicle is composed essentially of a fiber composite material, wherein the spokes of the wheel are each formed with a longitudinally extending cavity and said cavity is fluidically connected to a rim well or to a tire-rim space formed by the rim well and a mounted tire via an air passage opening, with the result that both monitoring of the hollow spokes for damage and in the case of tire damage is possible by a tire pressure monitoring device arranged in the wheel.

### CROSS-REFERENCE TO RELATED APPLICATIONS

This application claims priority to German Patent Application No 10 2014 103 608.5, filed Mar. 17, 2014, which is incorporated by reference herein in its entirety.

### FIELD OF THE INVENTION

The invention relates to a wheel for a motor vehicle having air openings, which are arranged between wheel spokes of a rim spider, and a rim well, which is connected to the wheel spokes and, at the edge, in each case has a rim flange with an adjoining rim hump.

### BACKGROUND OF THE INVENTION

DE 10 2011 087 936 83, which is incorporated by reference herein, has disclosed a one-piece wheel composed of a fiber composite material having a rim well, which is arranged between two rim flanges, and a wheel spider, which merges into the rim flange. DE 196 01 778 A1, which is incorporated by reference herein, has furthermore disclosed a vehicle wheel with a rim spider which has air openings and is connected to a rim well. The rim spider comprises wheel spokes designed as hollow spokes. Moreover, DE 10 2004 037 956 A1, which is incorporated by reference herein, has disclosed a wheel sensor for a tire pressure monitoring system, which is arranged in the wheel at the rim well.

### SUMMARY OF THE INVENTION

There exists a need to be able to detect damage to the loadbearing wheel structure and/or a tire defect on a vehicle wheel.

The principal advantages described herein consist in that damage to a vehicle wheel composed of a fiber composite material and embodied with hollow spokes can be detected immediately by the driver. When it strikes a curb or the like, a wheel composed of fiber composite material reacts differently than a vehicle wheel composed of a cast material, e.g. aluminum. Whereas such damage is easy to detect from the outside in the case of a vehicle wheel composed of cast material, such damage typically occurs on the inside in the case of wheels composed of fiber composite materials, with the result that the damage cannot be detected visually from the outside. In order to be able to detect such damage as early as possible, provision is made for the vehicle wheel composed of a fiber composite material with its wheel spokes embodied as hollow spokes and with a longitudinally extending cavity to be in fluid communication in such a way via respective air passage openings with a tire-rim space formed by the rim well and a mounted tire that the cavity of the wheel spoke can in each case be subjected to the air pressure or tire pressure prevailing in the tire-rim space of the wheel, and the air pressure in the cavity of the wheel spoke and in the tire-rim space is in contact by means of a tire pressure monitoring device arranged in the wheel.

In particular, provision is made for the hollow spokes of the vehicle wheel each to have air passage openings in the region of a raised annular ridge, adjoining the rim well, of the rim hump, the air passage openings being directed toward the rim well or the tire-rim space.

The cavities of the hollow spokes of the wheel spider with the fluid connection to the tire-rim space of the wheel in conjunction with the tire pressure monitoring device thus provide the simple possibility of being able to detect damage to the wheel and/or tire damage through pressure loss since the air pressure of an intact wheel in the tire-rim space should correspond to the air pressure in the cavities of the wheel spokes.

The size of the air passage openings in the raised annular ridge of the rim hump is preferably smaller than the cross section of the cavities of the hollow spokes.

### BRIEF DESCRIPTION OF THE DRAWINGS

An illustrative embodiment of the invention is shown in the drawings and is described in greater detail below.

In the drawings:

FIG. 1 shows a diagrammatic illustration of a vehicle wheel embodied with hollow spokes and having an air passage opening from the hollow spoke to the rim well,

FIG. 2 shows an enlarged illustration, in accordance with FIG. 1, with the air passage opening arranged on the hollow spoke, and

FIG. 3 shows a vertical section through the vehicle wheel with the hollow spoke and the air passage opening, in accordance with FIG. 1, and a tire pressure monitoring device.

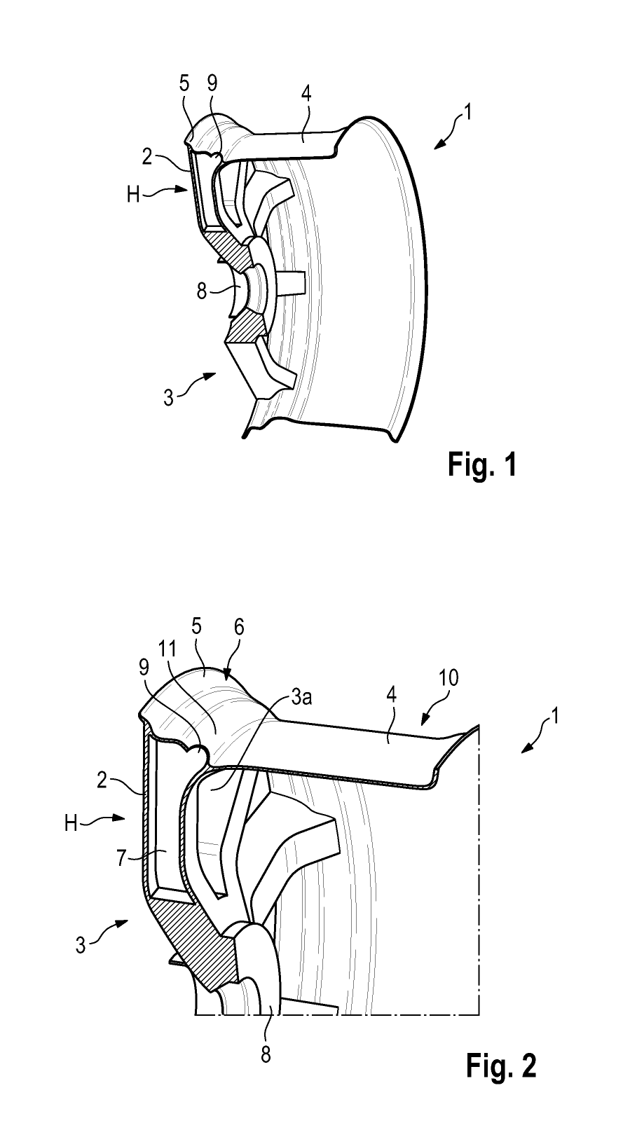

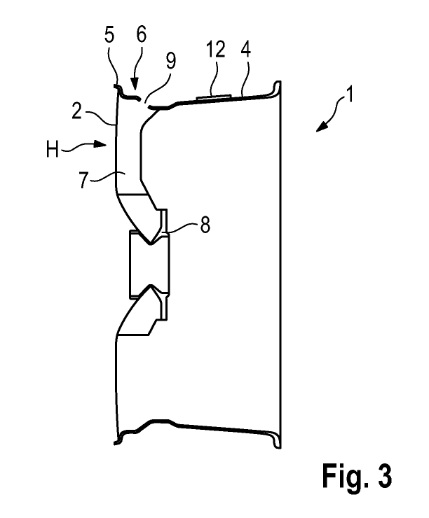

### DETAILED DESCRIPTION OF THE INVENTION

A wheel 1 for a motor vehicle has air openings 3a between wheel spokes 2 of a rim spider 3. Connected to the wheel spokes 2 on the outside is a rim well 4, which, at the edge, has rim flanges 5, each with a rim hump 6.

The vehicle wheel 1 with the rim spider 3 and the rim well 4 is composed essentially of a fiber composite material (CRP), wherein the wheel spokes 2 of the rim spider 3 are embodied as hollow spokes H, which each have a longitudinally extending cavity 7, which extends from a wheel hub 8 as far as the rim well 4. The cavity 7 of the wheel spoke 2 is in fluid contact via an air passage opening 9 with a tire-rim space 10, which is formed by the mounted tire (not shown) and the rim well 4.

Arranged in this space 10 or at some other location is a tire pressure monitoring device 12 (TPM), which is effective both for the vehicle tire (space 10) and for the cavity 7 of the hollow spoke H. In each case in the region of a raised annular ridge 11 of the rim hump 6, said ridge adjoining the rim well 4, this device has the air passage opening 9 directed toward the rim well 4 or the tire-rim space 10. In the hollow spoke H, this opening is preferably embodied so as to be smaller in cross section than the hollow cross section of the hollow spoke H.

Owing to the fluid connection, the cavities H of the wheel spokes 2 are subjected to the same air pressure as the tire-rim space 10, with the result that, in the event of damage to the loadbearing structure of the wheel 1, an air loss first of all occurs via the tire pressure monitoring device 12 and is, for example, detected by means of the tire pressure monitoring device 12, and the driver is warned or an indication given to check the vehicle wheel 1 in addition to the tire.

What is claimed is:

1. A wheel for a motor vehicle having air openings, which are arranged between wheel spokes of a rim spider, a rim well extending from the wheel spokes, a rim flange with an adjoining rim hump extending from the rim well, wherein the vehicle wheel with the rim spider and the rim well is composed of a fiber composite material and the wheel spokes are embodied as hollow spokes having longitudinally extending cavities, which are each fluidically connected via air passage openings to a tire-rim space formed by the rim well and a mounted vehicle tire such that the longitudinally extending cavities are subjected to an air pressure prevailing in the tire-rim space, and the air pressure in the longitudinally extending cavities and in the tire-rim space is in fluid communication with a tire pressure monitoring device arranged in the wheel.

2. The wheel as claimed in claim 1, wherein the hollow spokes are each arranged in a region of a raised annular ridge of the rim hump, said ridge adjoining the rim well and the air passage openings.

3. The wheel as claimed in claim 2, wherein, for each hollow spoke, the air passage opening in the raised annular ridge of the rim hump is smaller than a cross section of the longitudinally extending cavity in the hollow spoke.

4. The wheel as claimed in claim 1, wherein the cavities of the wheel spokes, which are subjected to the air pressure corresponding to the tire pressure in the tire-rim space, are configured to be monitored for air loss and/or for a wheel defect by the tire pressure monitoring device arranged in the vehicle wheel.

5. A wheel for a motor vehicle having wheel spokes and a rim well extending from the wheel spokes, wherein the vehicle wheel with the wheel spokes and the rim well is composed of a fiber composite material and at least one of the wheel spokes is embodied as a hollow spoke having a longitudinally extending cavity, which is fluidically connected via an air passage opening to a tire-rim space formed by the rim well and a mounted vehicle tire such that the longitudinally extending cavity is subjected to an air pressure prevailing in the tire-rim space, and the air pressure in the longitudinally extending cavity and in the tire-rim space is in fluid communication with a tire pressure monitoring device arranged in the wheel.
